(19) United States
(12) Patent Application Publication
(10) Pub. No.: US 2020/0384949 A1
(43) Pub. Date: Dec. 10, 2020

(54) Access Control System For A Motor Vehicle And Method For Controlling Access To A Motor Vehicle

(71) Applicant: U-Shin Deutschland Zugangssysteme GmbH, Erdweg (DE)

(72) Inventors: Dietmar Krauss, Erdweg (DE); Marc-Tell Lammich, Erdweg (DE)

(21) Appl. No.: 16/892,468

(22) Filed: Jun. 4, 2020

(30) Foreign Application Priority Data
Jun. 4, 2019 (DE) 102019114929.0

(51) Int. Cl. B60R 25/01; B60R 25/24; B60R 25/30

(52) U.S. Cl. CPC B60R 25/01; B60R 25/30; B60R 25/24

(57) ABSTRACT

This disclosure relates to an access control system for a motor vehicle. The motor vehicle includes at least one access element automatically adjustable between a closed position and at least one open position. The access control system includes at least an adjustment device for adjusting the access element between the open position and the closed position, and a detection device configured to detect at least one position of a portable key element relative to the motor vehicle by wireless transmission. The access control system further includes an environmental detection device configured to detect at least one environmental parameter, and a control device configured to control an adjustment movement of the access element depending on the detected position of the portable key element and depending on respective detected environmental parameters.

### TECHNICAL FIELD

The present invention relates to an access control for a motor vehicle. Furthermore, the present invention relates to a motor vehicle and a method for controlling access to a motor vehicle.

### STATE OF THE ART

The automatic access control of motor vehicles allows their convenient use. For example, an approach of a key element to a motor vehicle, wherein, for example, a user of the motor vehicle carries the key element with him, can be detected by wireless transmission and, depending on this, a vehicle door can be opened. The user or this person no longer needs to operate the vehicle door manually, for example by pulling a door handle and/or pressing a button on a key element configured as a remote control. In addition, the vehicle door can be fully opened before the person reaches the vehicle or the vehicle door. This makes it possible to enter the vehicle conveniently without delay.

A disadvantage of an automatic access control system, however, may be that the automatic system can cause an adjustment of the respective access elements of a motor vehicle, which does not or only partially correspond to the respective current wishes of the user. This may lead to inconvenient situations.

An automatic access control to a motor vehicle by wireless transmission is known, for example, from US 2018/0265039 A1. In addition, the vehicle's air conditioning system is set according to user preferences and/or weather data.

From JP 2008 227 789 A, access to a motor vehicle by wireless transmission is also known. Therein, respective signals of a wireless transmission connection are encrypted based on the ambient temperature.

### DESCRIPTION OF THE INVENTION

An object of the present invention is to improve automatic access control of motor vehicles to increase the convenience of the respective users.

This task is solved by the objects of the independent patent claims. Advantageous embodiments with appropriate further developments of the invention are indicated in the respective dependent claims.

A first aspect of the invention relates to an access control system for a motor vehicle. The motor vehicle may comprise at least one access element automatically adjustable between a closed position and at least one open position, such as a door, a window and/or a boot lid. This provides convenient automatic access to the motor vehicle for respective users. In particular, the adjustment may include a movement and/or unlocking or locking of a door lock. In the closed position, the access element may block an access opening to the motor vehicle. In the respective open positions, the access element can at least partially unblock the access opening, in particular to such an extent that it is possible to enter the motor vehicle. For example, a maximal open position may correspond to a maximum swing angle of the vehicle door away from its closed position. Correspondingly, further open positions may be provided between this maximal open position and the closed position in which an opening angle is smaller. Any open position smaller than the maximal opening angle may not allow boarding without the user manually moving the vehicle door further and/or orienting himself transversely to the access opening for boarding.

The access control system may include at least one adjustment device for adjusting the access element between its respective positions. For unlocking and/or opening, the adjustment device may comprise respective actuators. The adjustment device may be operatively connected to respective access elements for adjustment.

The access control system may further comprise at least one detection device configured to detect by wireless transmission at least one position of a portable key element relative to the motor vehicle. This allows the access elements to be adjusted by means of the adjustment device depending on the detected position of the key element respectively of a user carrying the key element. In particular, the vehicle door can thus be opened as soon as the vehicle is approached to allow delay-free entry without manual operation of the door.

The access control system may also include at least one environmental detection device configured to detect at least one environmental parameter. This enables, for example, the access control system to take into account the respective detected data representing the environment, in particular the weather.

Furthermore, the access control system may include a control device configured to control an adjustment movement of the access element depending on the detected position of the portable key element and depending on respective detected environmental parameters. This improves the automatic access control, since in addition to the position of the key element, environmental conditions, in particular the weather at the location of the motor vehicle, can also be taken into account. This can improve the convenience for the respective users. This is based on the realization that many owners find an automatic access control system, in particular an automatic opening of the respective doors, adapted to the weather conditions to be particularly convenient in different weather conditions.

Preferably, the access control comprises a plurality of access elements, which are automatically adjustable by means of the adjustment device and/or whose adjustment can be controlled by the control device. The environmental detection device is preferably configured to detect a plurality of environmental parameters. The detection device is preferably configured to detect respective positions of a plurality of key elements. The access control system may also comprise at least one or more key elements. Preferably, the control device is configured to control the adjustment movement depending on the detected position of the one key element or respective key elements and/or depending on the plurality of detected environmental parameters. Closing and/or opening of respective access elements can be controlled by the access control system or the control device depending on respective environmental parameters and detected positions of the key elements.

In the following, in the interest of simplification, it is often referred to the key element and to the environmental parameter. However, therewith it may also be referred to several key elements and/or several environmental parameters, if applicable. Similarly, several positions may be considered, even if only talking about the detected position. For example, several positions of one of the key elements can be detected chronologically one after the other to determine a speed and direction of movement. Depending on this, the adjustment of the access elements or respective access elements may be controlled.

Preferably, the at least one access element of the motor vehicle is a vehicle door, which can also simply be called a door. Preferably, the motor vehicle comprises several automatically adjustable doors. The adjustment device is preferably configured to adjust the respective access elements back and forth between the closed position and the respective open positions. However, the adjustment device may also be configured to adjust only from the closed position to the respective open positions or vice versa. The portable or carriable key element may be part of the access control system. For example, key elements can be configured as wireless transmission key, remote control, smartphone, smartwatch or chip card.

Preferably, the adjustment device is part of or arranged on the motor vehicle. The environmental detection device, the detection device and/or the control device may also be part of or arranged on the motor vehicle. In this way the access control system is particularly protected against unauthorized manipulation, in particular by a locked motor vehicle. However, these components may also be implemented in the key element, in particular in a key element configured as a smartphone. In this way the motor vehicle and the access control system can be particularly cost-effective. For example, the environmental detection device, the detection device and/or the control device may also be implemented at least partially on a central server. Thus, a very high level of computing power can be provided and/or it is easy to carry out modifications, maintenance and updates by the manufacturer.

In a further advantageous embodiment of the access control system, it is provided that the environmental detection device is configured to detect an outside temperature outside the motor vehicle, an amount of precipitation, an ambient brightness, a time, a wind force outside the motor vehicle, and/or a wind direction as respective environmental parameters.

The outside temperature usually has a strong influence on how quickly the user wants to get into the motor vehicle. In cold temperatures, for example, the user wants to get into the car quickly to avoid freezing. This can be taken into account by the control system, for example by opening the door particularly early in relation to the distance of the user relative to the motor vehicle. However, an open position with a small opening angle may also be preferred to reduce cooling of the vehicle due to warm air escaping. At high temperatures, for example, windows can be opened as access elements in addition to a door for ventilation when a user approaches.

A precipitation amount allows, for example, to determine whether and/or how much rain is falling. In connection with the temperature, it can also be determined if and/or how much snow is falling. In the case of heavy rain, for example, a late door opening in relation to the distance of the user from the vehicle can be provided. In other words, the door is only opened when the key element or user is at a short distance from the motor vehicle. This can reduce the risk of damage to the motor vehicle by moisture penetration.

By taking into account the time of day and ambient brightness, faster boarding and/or closing of respective access elements after boarding can be provided at night and/or in the dark, which can improve safety for respective users or at least a feeling of safety. Ambient brightness may also be a measure of solar radiation which may cause unwanted heating of the passenger compartment of the motor vehicle. This can then be counteracted by increasing the amount of automatic ventilation before the user enters.

By taking into account a wind force outside the vehicle and/or a wind direction, the ingress of dirt and/or rain through an unblocked access opening can be avoided or at least reduced. For example, an access opening facing away from the wind can be opened as a preference to minimize the intrusion of rain into the vehicle. In addition, respective access openings can be opened with a smaller opening angle and/or not opened at all if the wind around the vehicle could otherwise cause damage. For example, an actuator used to move a vehicle door may be too weak to keep the vehicle door in a certain open position or at a certain opening angle above a certain wind force and/or wind direction. By taking the wind into account, respective actuators and/or bearings of access elements may also potentially be configured to be less strong and/or stable, thereby reducing weight and/or costs.

Accordingly, the control device can be configured to take the above circumstances into account in the control or to control the adjustment movement of the respective access elements depending on the above circumstances.

The environmental detection device may comprise appropriate sensors to detect the above-mentioned environmental parameters. In particular, the environmental detection device may comprise an outdoor thermometer, a clock, a wind gauge, and/or a brightness sensor. The environmental detection device may also be configured to determine indirect values from respective sensor data or measured values, such as a type of precipitation (rain, snow, hail) and/or an intensity and direction of solar radiation (according to time and brightness).

In a further advantageous embodiment of the access control system it is provided that the environmental detection device is configured to determine respective environmental parameters by means of received weather data and a detected location of the motor vehicle. The environmental detection device can thus also detect respective environmental parameters indirectly via data reception, wherein, for example, the data can be contained in a digital weather report, in combination with respective location coordinates of the motor vehicle, wherein, for example, the location coordinates can be determined by means of a navigation system of the motor vehicle. This makes it possible to dispense with the need for additional and possibly expensive sensors to detect the respective environmental parameters. Also, a complex evaluation of sensor data may be omitted. The direct acquisition of environmental parameters by sensors can, however, provide more precise values and, in particular, take local environmental conditions, such as weather conditions at the location of the motor vehicle, into account more precisely. Both detections can also be provided in parallel, thus providing redundancy, for example.

In a further advantageous embodiments of the access control system it is provided that the control device is configured to adjust the access element between its respective positions depending on the detected position of the portable key element and to adapt at least one movement parameter of the adjustment movement depending on the respective detected environmental parameters. Depending on the respective detected positions of the key element, it can thus be controlled and/or determined, for example, whether respective access elements are to be opened or closed at all. This determination can be made, for example, depending on movement patterns, location of the key element, a direction of movement and/or a speed of movement and/or also include a prediction which access element will probably be used. Depending on the environmental parameter, the manner of adjustment can be determined or adapted. For example, depending on the respective environmental parameters, a timing, a speed and/or a duration of the adjustment to a certain position can be set, as well as, for example, the opening angle. The duration of the adjustment can also mean a period of time after which the access element is automatically closed again or returned to the closed position. In summary, the position of the key element can be used to determine whether particular access elements should be adjusted and how this adjustment should be carried out can be modified on the basis of the respective environmental parameters. With such a control system, the control can be very reliable and the adjustment can still be easily adapted to the user's needs according to environmental conditions.

Alternatively or additionally, the respective access elements to be adjusted can be selected depending on the respective environmental parameters. For example, in hot weather, in addition to a vehicle door, respective windows can also be opened, for example when access to the vehicle is unblocked for users on the basis of the recorded position of the key element. Similarly, a door facing away from the wind can also be selected for opening, even if it is not the closest door for the user.

In a further advantageous embodiment of the access control system it is provided that the respective movement parameters are an opening speed, an opening angle, an opening timing, which may be, in particular, a time lag for an adjustment of an access element starting with a distance of the portable key element from the motor vehicle falling under a minimum distance, and/or an opening time duration before the access element is adjusted back into the closed position. For example, the opening angle corresponds to the respective open positions and can be a measure of how far a vehicle door is opened.

In a further advantageous embodiment of the access control system it is provided that the control device is configured to adjust the access element between its respective positions depending on the respective detected environmental parameters in the case of different detected positions of the portable key element. Thus, for example, in the event of strong wind, adjustment of respective access elements can only be started when the key element is brought closer to protect the motor vehicle from potential damage. This can also be referred to as an opening parameter modification. For example, in bad weather the key element must be closer to the motor vehicle for automatic opening than in good weather. Environmental parameters can also be taken advantageously into account when determining which of the access elements the user is likely to use, for example in a prediction or usage probability calculation. For example, a user with the key element may move along a side of the vehicle facing away from the wind in order to be protected from the wind and weather, but still want to enter the vehicle on the side facing the wind, for example on the driver's side. This can be taken into account in a probability calculation with appropriate environmental parameters. This enables a particularly need-oriented control.

In a further advantageous embodiment of the access control system it is provided that the motor vehicle comprises a plurality of access elements which are automatically adjustable between a closed position and at least one open position, wherein the control device is configured to adjust a different number of the plurality of access elements between their respective positions depending on the respective detected environmental parameters in accordance with the detected position of the portable key element. Thus, opening additional access elements is possible in the case of hot outside temperature and/or strong solar radiation on the motor vehicle for rapid ventilation and/or cooling of an interior of the motor vehicle. Conversely, in bad and/or cold weather, only the access element needed for boarding, such as a driver's door, can be opened. Thus, the interior of the motor vehicle remains well protected despite automatic access control.

Advantageously, the access control system can be configured so that the adjustment movement of the respective access elements can be set depending on the respective environmental parameters, in particular by means of respective key elements. In particular, respective movement parameters can be adjustable. For example, an agile young user can configure the access control system in such a way that in bad weather, for example in heavy rain, a vehicle door is only automatically opened briefly and/or with a small opening angle. As a result, the vehicle interior can be particularly well protected against adverse environmental conditions. For the agile user, the loss of comfort resulting from the need to enter quickly and/or to enter the vehicle through an access opening that is only slightly open can be acceptable and/or hardly noticeable. For example, a less agile user may configure the access control system for the event of bad weather conditions, especially heavy rain, snow and/or ice, to automatically open a vehicle door for a long time and/or with a wide opening angle. For example, in these adverse environmental conditions, a less agile user may find it particularly difficult to get into his vehicle without falling. Thus, it is precisely then that comfortable boarding without rushing and with a generously unblocked access opening is particularly important for the user's convenience. For this less agile user, this advantage and the resulting increased safety can more than compensate for a possible disadvantage caused by a potential unintentional damping of the interior of his vehicle.

In particular, the configurability of the access control system thus makes it possible to meet individual comfort requirements. The access control system can also be configured so that respective settings, in particular settings of movement parameters, can be adjusted individually corresponding to respective access elements and/or key elements. This allows the access control system to react differently when a first key element is approaching than when a second key element is approaching in the same way and under the same environmental conditions. This means that the automatic adjustment of access elements can be configured differently for individual users or different key elements, in particular according to the requirements of the corresponding user.

A second aspect of the invention relates to a motor vehicle. The motor vehicle may comprise at least one or more access elements automatically adjustable between a closed position and at least one open position, such as a door, a window and/or a boot lid. Furthermore, the motor vehicle may also comprise an access control system according to the first aspect of the invention. This provides particularly convenient access to the interior of the motor vehicle, wherein the motor vehicle, in particular its interior, can be protected from damage caused by adverse environmental conditions. The features and advantages resulting from the access control system according to the first aspect are to be taken from the descriptions of the first aspect, wherein advantageous embodiments of the first aspect are to be regarded as advantageous embodiments of the second aspect and vice versa.

A third aspect of the invention relates to a method of controlling access to a motor vehicle. The motor vehicle may comprise at least one access element automatically adjustable between a closed position and at least one open position, such as a door, a window and/or a boot lid. In particular, it may be the motor vehicle according to the second aspect.

The method may include the step of detecting at least one position of a portable key element relative to the motor vehicle. This detection is preferably by wireless transmission and/or triangulation. The method may also include the step of detecting at least one environmental parameter. In addition, the method can comprise control of an adjustment movement of the access element depending on the detected position of the portable key element and depending on the respective detected environmental parameters.

The method according to the third aspect may be configured to control and/or operate the access control system according to the first aspect. This may provide particularly convenient and need-oriented access to the motor vehicle, wherein the motor vehicle can also be protected against adverse environmental conditions.

The characteristics and advantages resulting from the access control system according to the first aspect and the motor vehicle according to the second aspect are described in the descriptions of the first and second aspects respectively, wherein advantageous embodiments of the first or second aspect are considered to be advantageous embodiments of the third aspect and vice versa.

In a further advantageous embodiment of the method it is provided that whether the access element is opened and/or closed is controlled depending on the detected position of the portable key element and a manner of adjustment of the access element is set depending on the respective detected environmental parameters. This setting can generally concern the adjustment, such as opening speed, opening timing and/or opening angle. The manner of adjustment can be specified by a user, in particular by setting the respective movement parameters, as already described above as an example.

### BRIEF DESCRIPTION OF THE DRAWINGS

FIG. 1 shows in a schematic view a motor vehicle with an access control system.

### DETAILED DESCRIPTION OF EMBODIMENTS

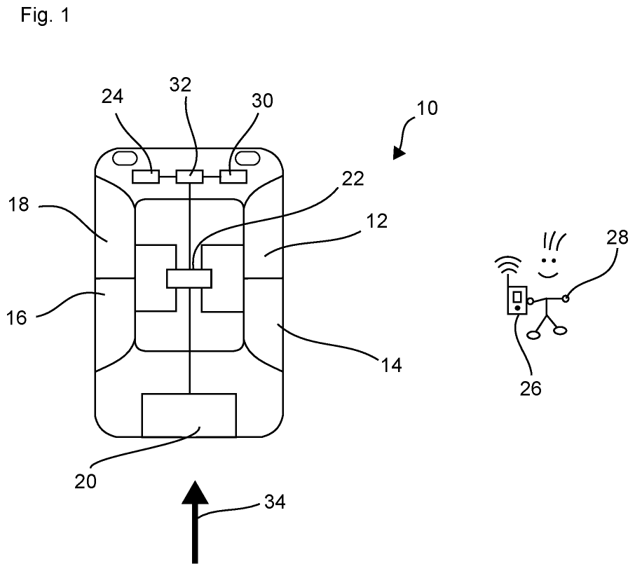

FIG. 1 shows in a schematic view a motor vehicle 10 with an access control system. This motor vehicle 10 comprises four doors 12, 14, 16, and 18 and a boot lid 20. Each of the doors 12, 14, 16, 18 comprises a window, which is not shown in FIG. 1. Each of the doors 12, 14, 16, 18, the boot lid 20 and the respective windows of the doors 12, 14, 16, 18 are automatically adjustable between a closed position and at least one open position. In the closed position, these block respective access openings to an interior space of the motor vehicle 10. In respective open positions, the respective access openings are at least partially unblocked, wherein the level of unblocking may correspond to a level of opening with respect to a maximal opening.

For the automatic adjustment of the respective access elements, the motor vehicle 10 comprises an adjustment device 22 which is in operative connection with the respective access elements. For example, the adjustment device 22 may comprise an actuator for each access element, which, if necessary, can unlock their lock and/or can, for example, swivel or move the access elements in translation.

Furthermore, the access control system of the motor vehicle 10 comprises a detection device 24 which is configured to detect at least one position of a portable key element relative to the motor vehicle with wireless transmission. For example, the detection device 24 can be installed in the motor vehicle 10. For determining the position of the key element, the detection device 24 can, for example, have three antennas to permit triangulation. However, modern wireless transmission standards can also allow to determine the direction and distance between respective transmitters or receivers using only one antenna. In the present case, the portable key element is configured as a smartphone 26, which is carried by a user 28. User 28 does not need to carry the key element in his hand. Carrying the key element on the body, even indirectly with a handbag, is also considered to be carrying in the present case. By means of the detection, a movement of user 28 and his distance and direction relative to motor vehicle 10 can be determined.

Furthermore, the access control system comprises an environmental detection device 30 which is configured to detect at least one environmental parameter. The environmental detection device 30 may be installed in the motor vehicle 10 and may comprise respective sensors. By means of the environmental detection device 30, for example, an outside temperature outside the motor vehicle, an amount of precipitation, an ambient brightness, a time, a wind force outside the motor vehicle and/or a wind direction can be detected as respective environmental parameters. Alternatively or additionally, the environmental detection device 30 can be configured to determine respective environmental parameters by means of received weather data and a detected location of the motor vehicle.

In addition, the access control system may include a control device 32 which is configured to control an adjustment movement of a respective one of the access elements by means of the adjustment device 22 depending on the detected position of the portable key element or smartphone 26 and depending on respective detected environmental parameters. In hot weather and/or strong sunlight, for example, in addition to the respective door 12, 14, 16, 18 whose use has been determined based on the position of the smartphone 26 relative to the motor vehicle respective adjustable windows can be opened. In cold weather, on the other hand, only the one of the doors 12, 14, 16, 18 which is expected to be used can be opened.

Arrow 34 in FIG. 1 illustrates a strong wind blowing against vehicle 10 from its rear side. This wind can advantageously also be taken into account by the access control system. For example, in such a wind situation, the respective doors 12, 14, 16, 18 are automatically opened only with a smaller opening angle when the smartphone 26 approaches. This can prevent the wind from catching the doors 12, 14, 16, 18 and pushing them open further unintentionally. For example, this could otherwise lead to damage to the motor vehicle 10.

### REFERENCE SIGNS

10 motor vehicle
12 door
14 door
16 door
18 door
20 boot lid
22 adjustment device
24 detection device
26 smartphone
28 user
30 environmental detection device
32 control device
34 arrow

1. An access control system for a motor vehicle, wherein the motor vehicle comprises at least one access element that is automatically adjustable between a closed position and at least one open position, wherein the access control system comprises:
an adjustment device for adjusting the at least one access element between the closed position and the open position;
a detection device configured to detect at least one position of a portable key element relative to the motor vehicle by means of wireless transmission;
an environmental detection device configured to detect at least one environmental parameter; and
a control device configured to control an adjustment movement of the at least one access element depending on the at least one detected position of the portable key element and depending on the at least one detected environmental parameter.

2. The access control system according to claim 1, wherein the environmental detection device is configured to detect an outside temperature outside of the motor vehicle, an amount of precipitation, an ambient brightness, a time, a wind force outside the motor vehicle, and/or a wind direction as the at least one detected environmental parameter.

3. The access control system according to claim 1, wherein the environmental detection device is configured to determine the at least one detected environmental parameter by means of received weather data and a detected location of the motor vehicle.

4. The access control system according to claim 1, wherein the control device is configured to adjust the at least one access element between the open position and the closed position depending on the detected position of the portable key element and configured to adapt at least one movement parameter of the adjustment movement depending on the at least one detected environmental parameter.

5. The access control system claim 4, wherein the at least one movement parameter is an opening speed, an opening angle, an opening timing, a time lag for an adjustment of an access element starting with a distance of the portable key element from the motor vehicle falling under a minimum distance, and/or an opening time period before the access element is adjusted back into the closed position.

6. The access control system according to claim 1, wherein the control device is configured to adjust the at least one access element between the open position and the closed position depending on the detected environmental parameters in a case of different detected positions of the portable key element.

7. The access control system according to claim 1, wherein the motor vehicle comprises:
a plurality of access elements automatically adjustable between respective closed positions and open positions,
wherein the control device is configured to adjust a different number of the plurality of access elements between their respective closed and open positions depending on the at least one detected environmental parameter in accordance with the at least one detected position of the portable key element.

8. A motor vehicle, comprising:
one or more access elements which are automatically adjustable between respective closed positions and open positions; and
an access control system according to claim 1.

9. A method for controlling an access to a motor vehicle, the motor vehicle comprising an access element that is automatically adjustable between a closed position and an open position, the method comprising:
detecting a position of a portable key element relative to the motor vehicle;
detecting an environmental parameter; and
controlling an adjustment movement of the access element depending on the detected position of the portable key element and depending on the detected environmental parameter.

10. The method according to claim 9, wherein whether the access element is opened and/or closed is controlled depending on the detected position of the portable key element, and wherein a manner of adjustment of the access element is set depending on the detected environmental parameter.

11. The access control system according to claim 1, wherein the at least one access element includes at least one of a door, a window, or a boot lid.

12. The motor vehicle according to claim 8, wherein the at least one access element includes at least one of a door, a window, or a boot lid.

13. The method according to claim 9, wherein the access element includes at least one of a door, a window, or a boot lid.
